(19) United States
(12) Patent Application Publication
(10) Pub. No.: US 2003/0163363 A1
(43) Pub. Date: Aug. 28, 2003

(54) Computerized prospect rating system and method

(75) Inventors: Richard V. Pratte, Bedford, NH (US); Tracy S. Hatch, Nashua, NH (US)

Correspondence Address: Bourque & Associates, P.A., Suite 301, 835 Hanover Street, Manchester, NH, 03104, US

(73) Assignee: Campagne Associates

(21) Appl. No.: 10/083,037

(22) Filed: Oct. 19, 2001

(51) Int. Cl. G06F 17/60

(52) U.S. Cl. 705/10

(57) ABSTRACT

A prospect rating system and method is used to identify top prospects from among a plurality of constituents. The user configures a plurality of rating elements by entering customized rating criteria used to calculate raw ratings for each of the rating elements. In one example, the rating elements relate to the constituent's connections to the organization, the concerns of the constituents matching those of the organization, and the capacity of the constituents to make a gift or other donation of time, money or materials. The rating criteria can include relative weight values, parameters, and rating points corresponding to the parameters. The customized rating criteria are applied to constituent data and raw ratings are calculated for each of the constituents. A percentile ranking can also be calculated for each of the constituents. The rating information is then output (e.g., displayed or printed) to indicate the top prospects, allowing the organization to plan strategies to more effectively achieve its goals.

### TECHNICAL FIELD

The present invention relates to computerized rating systems and methods and more particularly, to a prospect rating system and method for determining top prospects from among a plurality of constituents using customized rating criteria.

### BACKGROUND INFORMATION

Fundraising organizations rely heavily on fund raising and generally solicit a group of constituents (e.g., other organizations or individuals) to raise money for various causes. Fundraising is known to follow the 90/10 rule—90% of gifts come from 10% of the constituents. Fundraising organizations therefore want to focus on those constituents most likely to support the organization.

Fundraising organizations would like to know which constituents have the potential to become part of the “top tier” prospect pool so that the fundraisers can cultivate relationships with those top prospects. Fundraising organizations also would like to implement strategies for efficiently handling the lower tier prospects. By distinguishing between the top prospects most likely to give and the lower tier prospects, the fundraising organization can raise more money and meet its fundraising goals.

Computer systems and software have been used by fundraising organizations to store donor and prospect information, to track and manage gifts, and to facilitate contacting the donors and prospects. Existing fundraising software, however, has treated all donors alike. This software does not facilitate a strategy in which the top prospects are treated differently than the lower tier prospects. Thus, this software is limited in its ability to help a fundraising organization effectively achieve its goals.

Accordingly, there is a need for a system and method in which a computer is used to determine top prospects from among a group of constituents based on rating elements customized by the user.

### SUMMARY

In accordance with one aspect of the present invention, computerized prospect rating method determines top prospects from among a plurality of constituents based on a plurality of rating elements. The top prospects are preferably most likely to give to an organization. The method comprises receiving customized rating criteria from a user for allowing the user to customize the rating elements. The rating elements preferably include at least commitment rating elements for measuring a commitment made by a constituent to the organization, concern rating elements for measuring a concern of a constituent matching concerns of the organization, and capacity rating elements for measuring a financial ability of a constituent to give to the organization.

The method also comprises applying the customized rating criteria to constituent data corresponding to each of the constituents and calculating raw ratings for each of the rating elements based upon the constituent data for each of the constituents. Each of the constituents is then ranked based on the raw ratings. Rating information indicating the top prospects is then output.

In accordance with another aspect of the present invention, a computerized prospect rating method determines top prospects from among a plurality of constituents based on a plurality of rating elements. This method comprises displaying a customization user interface for allowing a user to customize the rating elements. Relative weight values are assigned to each of the rating elements, and the relative weight values represent an importance of each of the rating elements in determining the top prospects. Rating parameters and rating values are set corresponding to the rating parameters for each of the rating elements.

The method further comprises applying the rating parameters to constituent data corresponding to each of the constituents and calculating raw ratings for each of the rating elements based on the rating values and the relative weight values. An overall raw rating and/or a percentile ranking for each of the constituents is then calculated. The overall raw rating is a sum of the raw ratings calculated for each of the rating elements. The percentile ranking ranks each of the constituents with respect to other constituents. The rating information indicating the top prospects is then output.

In accordance with other aspects, the present invention provides computer program products or software for performing the methods defined above.

In accordance with a further aspect of the present invention, a system determines top prospects from among a plurality of constituents based on a plurality of rating elements. The system comprises a customization user interface for receiving customized rating criteria for each of the rating elements and comprises a rating element data structure for storing the customized rating criteria. The system also comprises a constituent database containing constituent data for each of the constituents. A rating engine applies the customized rating criteria to the constituent data for each of the constituents, calculates raw ratings for each of the rating elements, and ranks each of the constituents based on the raw ratings. The system also includes an output device for outputting the rating information.

### BRIEF DESCRIPTION OF THE DRAWINGS

These and other features and advantages of the present invention will be better understood by reading the following detailed description, taken together with the drawings wherein:

FIG. 1 is a functional block diagram of a prospect rating system, according to one embodiment of the present invention;

FIG. 2 is a flow chart illustrating a prospect rating method, according to one embodiment the present invention;

FIG. 3 is a screen shot of a prospect rating settings profile showing user customized relative weight settings, according to one embodiment of the present invention;

FIGS. 4-7 are screen shots of relative weight adjustment prompts, according to one embodiment of the present invention;

FIG. 8 is a screen shot of a prospect rating settings profile showing user customized parameters for commitment elements, according to one embodiment of the present invention;

FIG. 9 is screen shot of a drop down list for customizing a time period parameter in the prospect rating settings profile shown in FIG. 8;

FIG. 10 is a screen shot of a prospect rating settings profile showing user customized parameters for concern elements, according to one embodiment of the present invention;

FIGS. 11-13 are screen shots of a prospect rating settings profile showing parameters for capacity elements, according to one embodiment of the present invention;

FIG. 14 is a screen shot of a constituent profile showing the raw ratings for each of the rating elements, according to one embodiment of the present invention;

FIG. 15 is a screen shot of constituent data for a selected rating element, according to one embodiment of the present invention;

FIG. 16 is a screen shot of changes to donor prospect ratings, according to one embodiment of the present invention;

FIG. 17 is a screen shot of a user customizable prospect rating change parameter, according to one embodiment of the present invention; and

FIG. 18 is a screen shot of a top prospect profile report, according to one embodiment of the present invention.

### DETAILED DESCRIPTION OF THE PREFERRED EMBODIMENTS

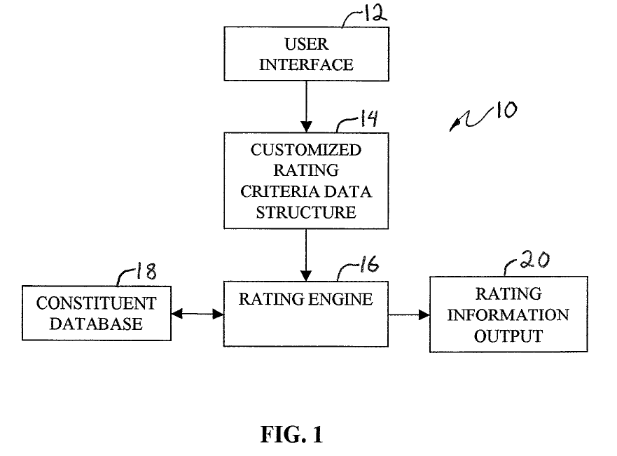

A prospect rating system 10, FIG. 1, according to one aspect of the present invention, is used to determine top prospects from among a plurality of constituents such as organizations or individuals. The prospect rating system 10 uses customizable rating elements to rate the constituents and rank them against one another. In the exemplary embodiment, the prospect rating system 10 is used by fundraising organizations to identify the top prospects most likely to give to the organization. The prospect rating system 10 can also be used by other organizations to identify other types of prospects, and the enclosed description and Figures references fundraising activities for exemplary purposes only, and not as a limitation on the present invention.

The prospect rating system 10 is preferably implemented using computer hardware and software. In one embodiment, the prospect rating system 10 is implemented as a computer software program running on a Personal computer (PC) with a Windows-based operating system. The prospect rating system 10 can run on a stand-alone single machine, over a network, or in a client/server architecture.

In one example, the software is created using Microsoft Visual basic programming language and runs under the Windows operating system, although this is not a limitation of the present invention.

The prospect rating system 10 can be implemented as a stand-alone software product or incorporated into other software products such as other fundraising software.

The prospect rating system 10 comprises a user interface 12 for displaying the rating elements to a user and for allowing the user to customize the rating elements with customized rating criteria. The prospect rating system 10 also comprises a customized rating element data structure 14 for use in determining the top prospects.

A rating engine 16 applies the customized rating criteria from the data structure 14 to constituent data from a constituent database 18 and calculates ratings and/or rankings for each of the constituents. A rating information output 20 outputs the rating information (e.g., by displaying or printing) to allow the user to identify the top prospects. Rating information for each constituent can also be stored in the constituent database 18. As constituent data and/or customized rating criteria change, the rating engine 16 can recalculate ratings and/or rankings.

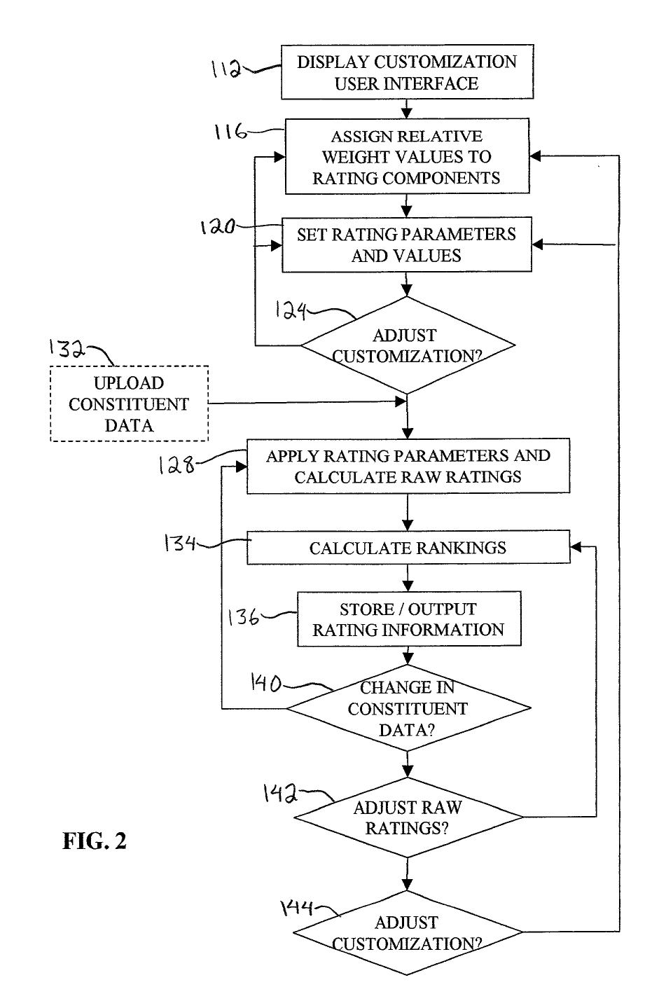

Referring to FIG. 2, a prospect rating method, according to one preferred embodiment, is shown and the acts necessary to carry out this method described. A customization user interface is displayed, step 112, for allowing a user to customize the rating elements with customized rating criteria used to rate the prospects. In the exemplary embodiment used to identify top donor prospects, the rating elements relate to the prospect's commitment to the organization, the prospect's concerns matching those of the organization, and/or the prospect's capacity to make a donation, as will described in greater detail below.

The customization preferably includes assigning relative weight values to each of the rating elements, step 116, and setting rating parameters and rating values corresponding to the parameters for each of the rating elements, step 120. The relative weight values represent the importance of the rating elements in determining the top prospects and the rating values quantify the rating elements. At any time the user can adjust the customization of the rating elements, step 124.

When the rating elements are customized, the rating parameters are applied to constituent data and the raw ratings are calculated for each rating element based on the rating values and the relative weight values, step 128, as will be described in greater detail below.

In the exemplary embodiment, the constituents can be existing donors or potential donors who have not previously given to the organization. The constituent data may be located on the same system or uploaded from a separate database, step 132. After the raw ratings are calculated, the constituents are ranked, for example, by calculating percentile rankings based on the overall raw ratings for the constituents, step 134.

The rating information for each of the constituents is then stored and/or output, step 136. If the constituent data changes over time, step 140, the rating parameters can be applied again to the updated constituent data to calculate new raw ratings, step 128. After the raw ratings are calculated, the user can adjust the raw ratings directly, step 142, for example, based on criteria not addressed by the rating elements, as will be described in greater detail below.

The adjusted raw ratings can then be used to update the rankings calculation, step 134. The user can also adjust the relative weight values, the rating parameters, and/or rating values corresponding to the parameters after the raw ratings are calculated, step 144. The updated relative weight values, the rating parameters, and/or rating values are then used to calculate new raw ratings, step 128.

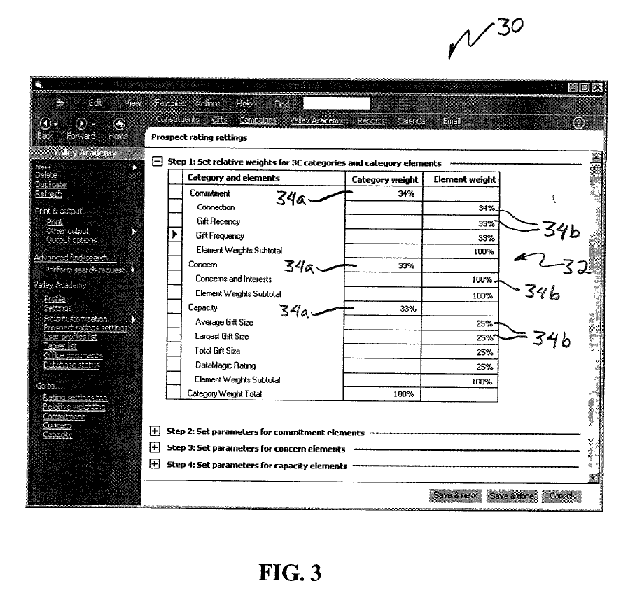

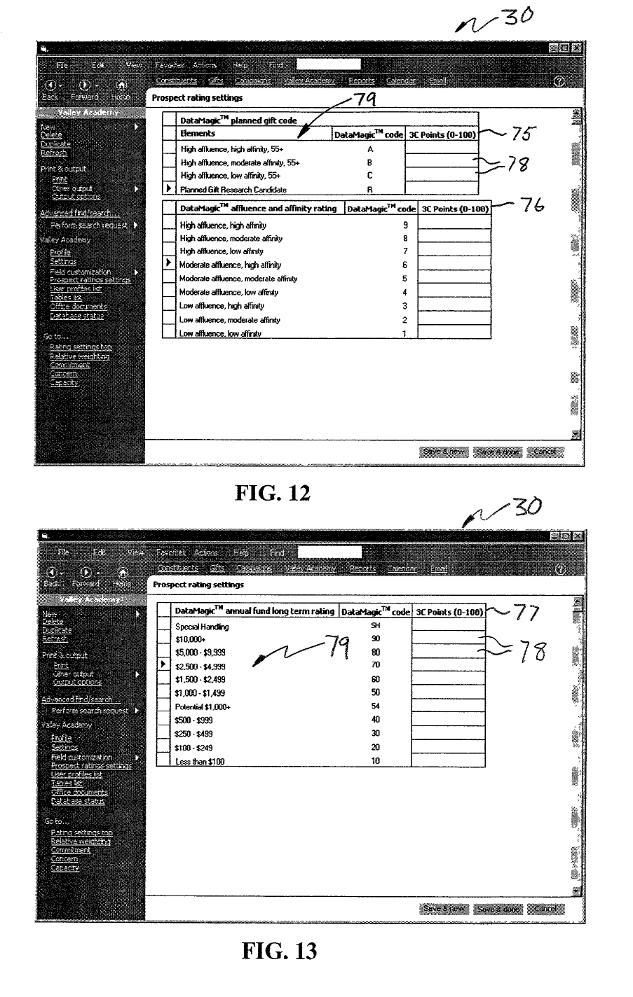

Referring to FIGS. 3-18, the exemplary embodiment of the prospect rating system and method is described in greater detail. The customization user interface preferably comprises a prospect rating settings profile 30 (as shown in FIGS. 3, 8 and 10-13) for identifying the rating elements and providing data entry fields for entering relative weight values, rating parameters, and rating values or points corresponding to each of the rating parameters. The prospect rating settings profile 30 is displayed in one or more windows with links that allow the user to open various sections of the profile 30. Although one form of graphical user interface (GUI) is shown, the GUI can also have other designs.

In the exemplary embodiment, the rating elements used to rate prospects most likely to donate to an organization relate to three rating categories—commitment, concern, and capacity. The commitment rating elements quantify how involved a constituent is with the organization. The concern rating elements quantify how the concerns of the constituents match the core values of the organization. The capacity rating elements quantify the financial ability of the constituents to give a significant gift. Although these three rating categories are preferred for a prospect rating system used by a fundraising organization to identify top donor prospects, different categories can be used depending upon the goals of the organization and the type of prospects.

The commitment rating elements include, but are not limited to, a connection element, a gift recency element, and a gift frequency element. The connection element relates to the connections a constituent has to an organization and the significance of the connections. The gift recency element relates to the most recent gift made by the constituent and the time period for that gift. The gift frequency element relates to how often the constituent gives to the organization.

The concern rating elements include, but are not limited to, a list of concerns and interests. The concerns and interests relate to the core values of the organization that might match the concerns and interests of the constituents.

The capacity rating elements include, but are not limited to, an average gift element, a largest gift element, a total giving element, and an external source of information such as an information element from DataMagic™ which is a source of external information regarding a prospects potential for giving.

The average gift element relates to the average gift size given by the constituent over time. The largest gift element relates to the largest gift the constituent has ever given. The total giving element relates to the total amount of all gifts made by the constituent. The DataMagic™ element allows the user to utilize external in-depth screening information about the prospect's capacity to donate and is typically compiled from a number of external sources of information. Other external capacity rating elements may include company matching gift information, asset information, employment information, level of education, and affiliations.

To assign relative weight values to the categories and/or the rating elements in the exemplary embodiment, the prospect rating settings profile 30 includes a relative weight section 32 (FIG. 3). The relative weight section 32 displays a list of the rating elements organized according to the rating categories with data fields 34 for entering the relative weight values corresponding to each rating element and/or category. The user enters the relative category weight values in the data fields 34a to best reflect the importance of the commitment category, concern category, and capacity category in determining a top prospect. The user also enters relative element weight values in the data fields 34b to reflect the importance of each rating element within a particular category.

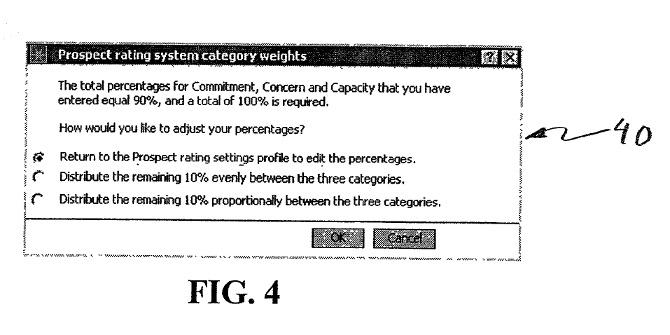

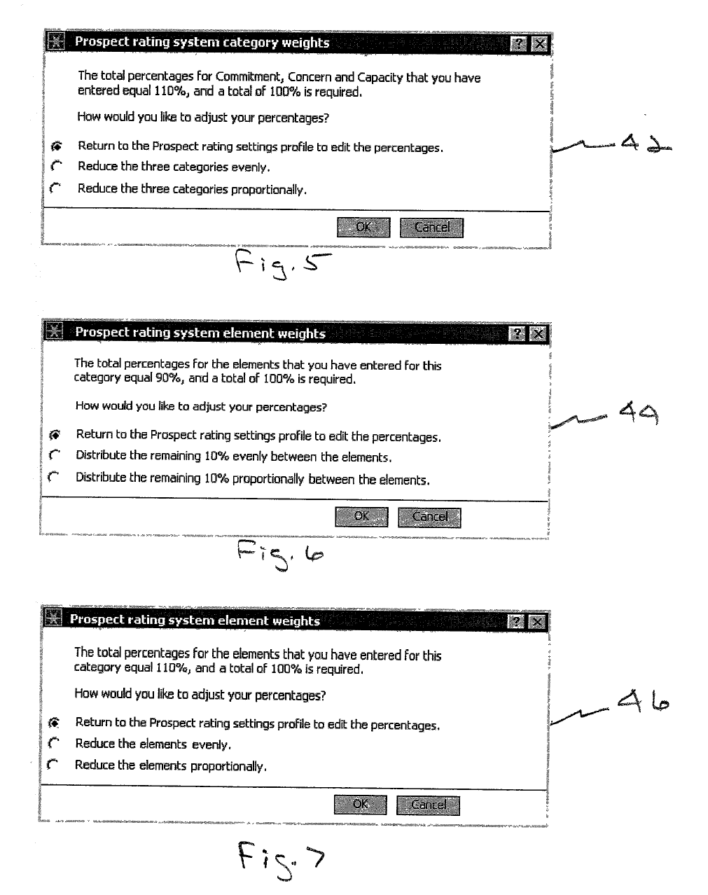

The relative weight values are preferably entered as percentages and the relative category weights should add up to 100%. The prospect rating system displays prompts 40, 42 to the user asking how an adjustment should be made if the relative weights entered by the user add up to less than the desired 100% (FIG. 4) or if the relative weights entered by the user add up to more than the desired 100% (FIG. 5). Similarly, the relative element weights within each category should also add up to 100%. Prompts 44, 46 are displayed, if the relative weights add up to less than 100% (FIG. 6) or add up to more than 100% (FIG. 7).

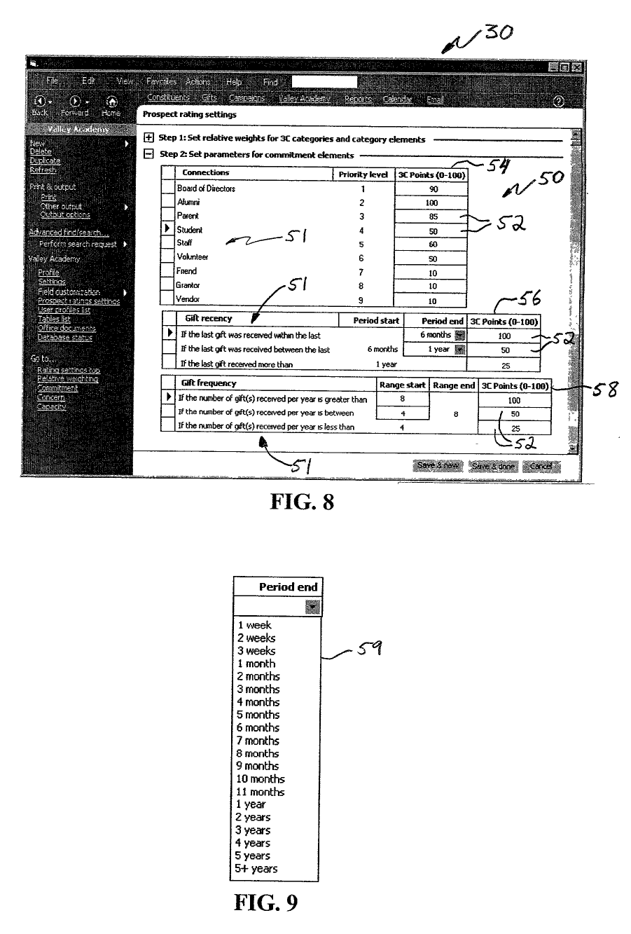

To set the parameters for calculating the rating points for the commitment elements, the prospect rating settings profile 30 includes a commitment element parameter section 50 (FIG. 8). The commitment element parameter section 50 includes tables 54, 56, 58 for each of the commitment elements. The commitment element tables 54, 56, 58 include the commitment element parameters 51 and data fields 52 for entering rating values or points corresponding to the parameters 52.

The commitment elements measure how closely tied constituents are with the organization by looking at the relationship and roles they play and their pattern of giving. For the connections element, the parameters include possible connections to the organization preferably listed according to priority level. The user enters rating points in the data fields 52 in the connections element table 54 for each of the possible connections according to the likelihood that a constituent having that connection will give to the organization.

For example, the user enters the largest possible number of points (e.g., 100 points) for an alumni connection, indicating that alumni are most likely to give. Although the exemplary embodiment shows certain types of possible connections, other possible connections are also contemplated. The possible connections can be established by the organization when an organization profile is originally created and configured in the prospect rating system 10, and can be added to and/or modified over time.

The gift recency element identifies donors giving a recent gift showing that they have a current and active commitment to the organization. For the gift recency element, the parameters 51 include user definable time periods in which the last gift was received. In the exemplary embodiment, the user defines three time periods in the gift recency element table 56, for example, by selecting options from a drop down list 59, as shown in FIG. 9.

First, the user enters the end of the first or most recent period, i.e., gifts received from today until the end of the chosen period (e.g., gifts received within the last 6 months). The end of the first period becomes the beginning of the middle period, and the user defines the end of the middle period (e.g., gifts received between 6 months and 1 year). The end of the middle period becomes the start of the last period (e.g., gifts received over 1 year ago).

The user enters the number of rating points corresponding to each of the time periods, e.g., the highest number of rating points should be entered for the first or most recent period in the data fields 52 of the gift recency table 56.

The user can define the time periods based upon how often the organization gives prospects an opportunity to give a gift. For example, if monthly mailings are sent, the user may want to define a middle or average period of 1 to 3 months. If solicitations are mailed once a year, the user may want to set the middle period of 1 to 2 years. Although the exemplary embodiment allows the user to define three gift recency ranges, a larger or smaller number of ranges can be defined.

The gift frequency element identifies a donor's commitment to the organization based on how often the donor gives. For the gift frequency element, the parameters 51 include a user definable number of gifts received within a time period (e.g., within 1 year). In the exemplary embodiment, the user defines three gift frequency ranges in the gift frequency table 58. For example, the user sets the start of the first or most frequent range (e.g., 8 gifts per year) and the start of the middle frequency range (e.g., 4 gifts per year). In the data fields 52 of the gift frequency table 58, the user enters the rating points for each range, e.g., the higher number of points are entered for the most frequent range.

The user can define the frequency ranges based on how often the organization solicits. For example, if the organization solicits often and typically receives 4-6 gifts a year from a donor, the user may want to set 4 to 6 as the middle range. If the organization solicits only once or twice a year, the middle or average gift frequency period should be set between 1 and 2. Although the exemplary embodiment allows the user to define three gift frequency ranges, a larger or smaller number of ranges can be defined.

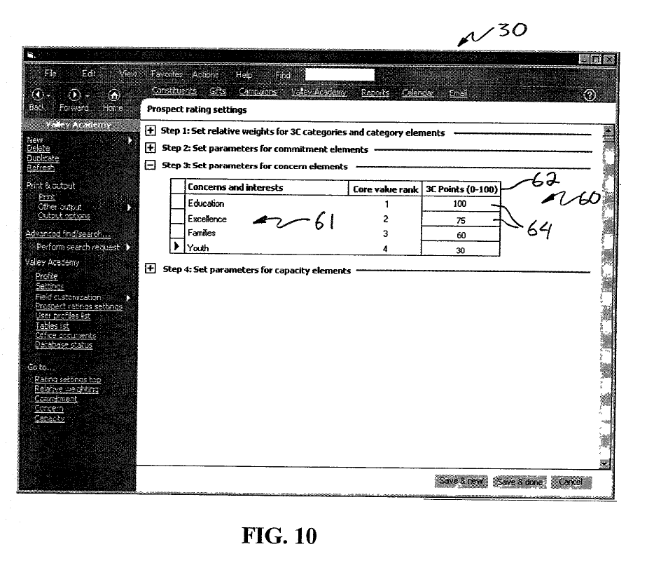

To set the parameters for calculating the rating points for the concern elements, the prospect rating setting profile 30 includes a concern elements parameter section 60 (FIG. 10). The concern elements section 60 includes a concerns and interests table 62 including the parameters 61 and data fields 64 for entering rating points corresponding to the parameters.

The concern element identifies constituents who share a passion for the core values of the organization and thus are good prospects to become more closely aligned with or committed to the organization. For the concern element, the parameters 61 include concerns and interests listed according to core value rank (e.g., education, excellence, families and youth). These concerns and interests are preferably set when an organization profile is originally created and configured in the prospect rating system 10. The user enters rating points in the data fields 64 for each of the concerns and interests according to the likelihood that a constituent with that concern/interest will give to the organization. The core values of the organization are also typically identified and set forth by the organization when the organization is established and the software set up.

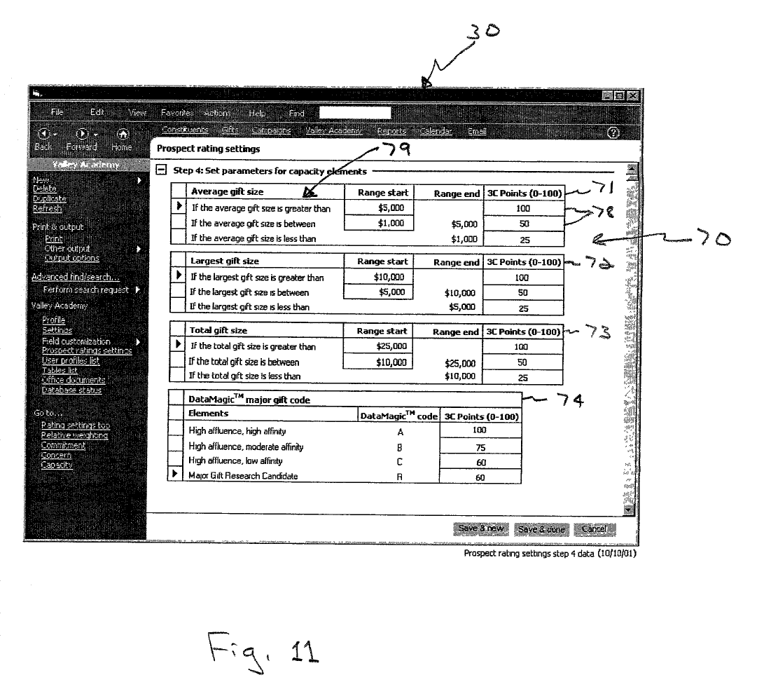

To set the parameters for calculating the rating points for the capacity elements, the prospect rating settings profile 30 includes a capacity element parameter section 70 (FIGS. 11-13). The capacity element parameter section 70 includes tables 71-77 for each of the capacity elements. Each of the tables 71-77 include the capacity element parameters 79 and data fields 78 for entering rating points corresponding to the parameters.

The capacity elements measure the ability of a constituent to give a significant gift by looking at past giving. The capacity elements include average gift size, largest gift size and total gift size elements. In the tables 71-73 for these gift size elements, the user sets the ranges of gift sizes as the parameters 79 and enters the corresponding point values in the data fields 78 (FIG. 11). The rating points are preferably entered such that the gifts in the higher ranges have more points. Although the exemplary embodiment allows the user to define three ranges for each of these gift size elements, a larger or smaller number of ranges can be defined for any one of these elements.

The capacity elements optionally include DataMagic™ elements for measuring capacity based on professional affluence research. In the DataMagic™ element tables 74-77, the parameters 79 are listed with DataMagic™ codes and the user enters in the data fields 78 rating points corresponding to each of the DataMagic™ codes.

The user can adjust the customized rating criteria within any of the sections discussed above at any time using the prospect rating settings profile 30. When the user has established the desired customization of the rating elements, the user can then proceed with determining the ratings and/or rankings for the constituents.

The customized rating criteria (e.g., the relative weights, rating parameters, and rating points) for each of the rating elements is stored in data structures, for example, as tables. The customized rating criteria is then applied to the constituent data for each of the constituents, and raw ratings are calculated for each of the rating elements and for each of the categories. The constituents are then ranked based on the raw ratings, and a percentile ranking is calculated for each of the constituents.

The raw ratings calculations are made by applying the parameters for each rating element to the constituent data for each constituent. If the constituent data matches one of the parameters within a rating element, the constituent earns the rating points corresponding to that parameter. For rating elements where the constituent data can match more than one parameter, the rating points corresponding to each of the matching parameters are totaled. If a constituent matches multiple connection parameters as a board director, a parent and a volunteer, for example, the constituent earns the rating points corresponding to each of those connection parameters. If the constituent matches the same parameter more than once (e.g., the constituent was a board member more than once), the constituent only earns the rating points for a board member parameter once.

To determine the raw rating for each rating element, the rating points earned by the constituent for each rating element are weighted by multiplying the rating points by the relative element weight value assigned to that rating element. Each category raw rating is then determined by summing the raw ratings for the rating elements within the category and multiplying by the relative category weight value assigned to the category. An overall raw rating is then determined by summing the category raw ratings. The raw ratings for all of the constituents are used to rank the constituents and to calculate percentile rankings for the constituents.

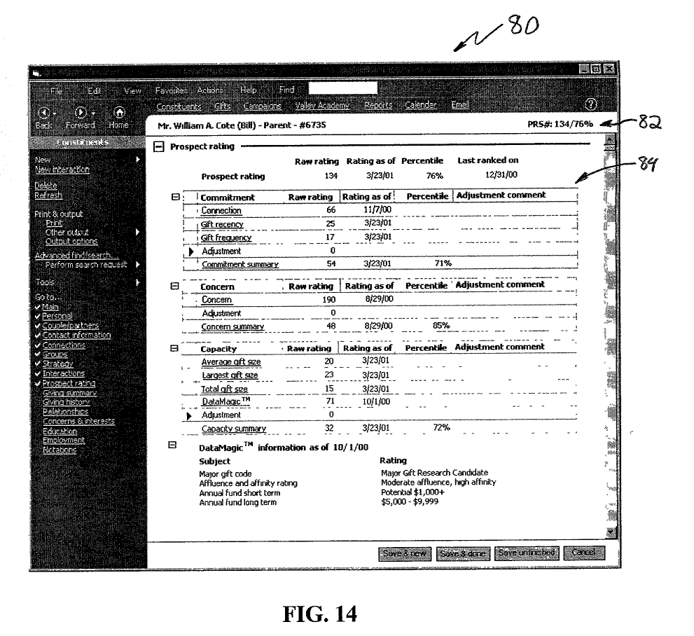

The raw ratings and percentile ranking can be displayed for each constituent on a constituent profile 80 (FIG. 14). The constituent profile 80 includes a profile header 82 displaying the constituent name, primary connection, overall raw rating, and percentile ranking. The constituent profile 80 also includes a prospect rating section 84 listing the categories and rating elements, the associated raw ratings, and the dates of the raw ratings. The prospect rating section 84 can also include percentile rankings for each of the rating categories.

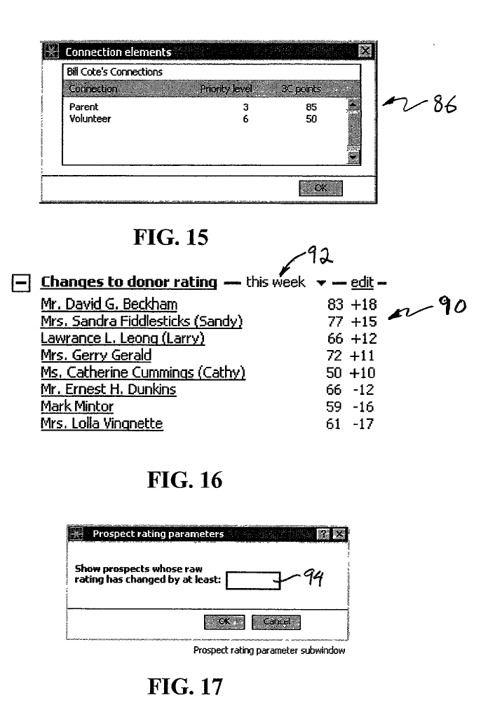

The user can click on a rating element in the prospect rating section 84 to display rating element information 86 for that constituent (FIG. 15). Connection rating element information, for example, includes the connections applicable to that constituent (e.g., parent and volunteer) and the rating points earned for those connections.

For any one of the constituents, the user can make a direct adjustment to the raw rating calculated for each of the rating elements and/or for each of the categories. These raw rating adjustments can be based on other constituent information not addressed by the rating element parameters. In one example, the raw rating calculated for the commitment element can be increased for a constituent who volunteers whenever asked or decreased for a constituent board member who never attends board meetings. In another example, the raw rating for the concern element can be increased for a constituent known to be involved in several other similar organizations or decreased for a constituent who quickly loses interest in a concern. In a further example, the raw rating for the capacity element can be increased for a constituent known to have won the lottery or can be decreased for a constituent that has just gone into receivership. In the exemplary embodiment, this adjustment (positive or negative) can be made within the constituent profile 80 together with a comment about why the adjustment is made.

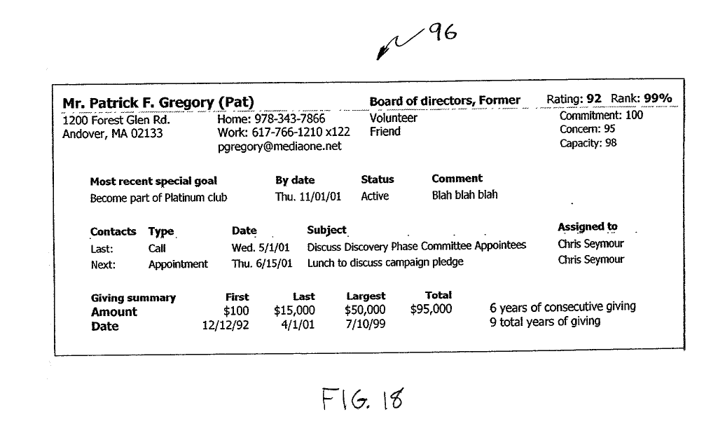

The raw ratings are updated directly when the user makes adjustments to the raw ratings. The raw ratings are also updated indirectly when the user makes adjustments to the rating criteria used to calculate the raw ratings. The raw ratings can also be continuously updated as information about the constituent changes (e.g., gives a gift or joins the Board of Directors). When raw ratings change, the user can initiate a recalculation of the percentile ranking. The prospect rating system 10 can also display a prospect rating change list 90 including constituents having a defined change in raw ratings within a defined period of time (FIG. 16). The period of time (e.g., today, yesterday, this week, last week, this month, last month) can be selected by the user, for example, using a drop down list 92. The amount of the change in ratings can also be set by the user by entering a change amount in a data field 94 (FIG. 17).

In the exemplary embodiment, the rating information can be provided in the form of top prospect reports either displayed or printed. In one example, the top prospects report gives a list of all constituents having a percentile ranking greater than or equal to 90%. This report includes the constituent's name, primary connection, percentile ranking, overall raw rating and raw rating for each of the rating categories. Other information on the report can include, but is not limited to, the next scheduled interaction and the last interaction for each constituent. The list of constituents can be sorted according to the percentile ranking or any other information.

Rating information can also be provided in a top prospects strategy report. The top prospects strategy report can include the information in the top prospects report plus additional information about the goals set as part of the strategy of the organization.

Rating information can also be provided in a top prospect profile report 96 (FIG. 18). The top prospect profile report 96 includes “snapshots” of information about a prospect for use in prospect review sessions, creating strategies, briefing solicitors, and in various other ways.

Once the top prospects are identified, the organization can focus on the top prospects. The organization can see who the top prospects are today, identify who is likely to move up, and identify those who slipped out of the top prospect ranking. The organization can also plan strategies using the rating information for the prospects. If the rating information indicates that someone is a good prospect for the Board, for example, the organization can plan a strategy to recruit that prospect to the Board. In another example, if the rating information indicates that someone has the potential to make a sizable gift (i.e., a high capacity rating), the organization can plan a strategy to persuade her to underwrite one of the organization's programs. In a further example, if the rating information indicates that someone has strong commitment and concern ratings, but a low capacity rating, the organization can plan a strategy to learn more about the prospect's financial ability or to find other ways to have the prospect support the organization.

The organization can also use the rating information to plan and implement interactions with prospects. For example, the organization can send a special mailing or email to all of the top prospects or contact them directly. The organization can also set goals for the group of top prospect and assign solicitors for the group. The organization can also keep track of how often these top prospects are approached and the success rate.

Accordingly, the prospect rating system of the present invention allows an organization, such as a fundraising organization, to identify top prospects or constituents using rating elements that can be customized by the organization. The organization thus has control over the factors used to identify the top prospects. Identifying the top prospects and the rating information can help the organization plan strategies to more effectively achieve its goals or collecting money, getting volunteers, identifying.

Modifications and substitutions by one of ordinary skill in the art are considered to be within the scope of the present invention, which is not to be limited except by the following claims.

The invention claimed is:

1. A computerized prospect rating method for determining top prospects from among a plurality of constituents based on al least one rating element, wherein said top prospects are most likely to give to an organization, said method comprising the acts of:
receiving customized rating criteria from a user for allowing the user to customize said at least one rating element, wherein said at least one rating element is selected from the group consisting of: commitment rating elements for measuring a commitment made by a constituent to the organization, concern rating elements for measuring a concern of a constituent matching concerns of the organization, and capacity rating elements for measuring a financial ability of a constituent to give to the organization;
applying said customized rating criteria to constituent data corresponding to each of said constituents and calculating raw ratings for each of said rating elements based upon said constituent data for each of said constituents;
ranking each of said constituents based on said raw ratings; and
outputting rating information indicating said top prospects.

2. The method of claim 1 wherein said customized rating criteria includes rating parameters and rating values corresponding to said rating parameters, and wherein said raw rating is calculated based on said rating values earned by constituents when constituent data matches one of said rating parameters.

3. The method of claim 1 wherein said customized rating criteria further includes relative weight values assigned to each of said rating elements, and wherein said raw ratings are determined by multiplying said rating values by said relative weight values for each of said rating elements.

4. The method of claim 1 further comprising calculating raw ratings for rating categories, wherein said rating categories include a commitment category, a concern category, and a capacity category.

5. The method of claim 1 wherein ranking said constituents includes calculating a percentile ranking for each of said constituents.

6. The method of claim 1 wherein said constituents ranked in about the top 10% are identified as said top prospects.

7. The method of claim 1 further comprising directly adjusting at least one of said raw ratings.

8. The method of claim 1 further comprising recalculating said raw ratings continuously as said constituent data changes.

9. The method of claim 8 wherein said rating information includes a list of constituents having a defined rating change within a defined period of time.

10. The method of claim 1 further comprising uploading constituent data from another constituent database.

11. A computerized prospect rating method for determining top prospects from among a plurality of constituents based on a plurality of rating elements, said method comprising:
displaying a customization user interface for allowing a user to customize said rating elements;
assigning relative weight values to each of said rating elements, wherein said relative weight values represent an importance of each of said rating elements in determining said top prospects;
setting rating parameters and rating values corresponding to said rating parameters for each of said rating elements;
applying said rating parameters to constituent data corresponding to each of said constituents and calculating raw ratings for each of said rating elements based on said rating values and said relative weight values;
calculating at least one of an overall raw rating and percentile ranking for each of said constituents, wherein said overall raw rating is a sum of said raw ratings calculated for each of said rating elements, and wherein said percentile ranking ranks each of said constituents with respect to other said constituents; and
outputting rating information indicating said top prospects.

12. The method of claim 11 wherein said rating elements are arranged by categories, wherein relative weight values are assigned to said categories, and wherein said raw ratings are calculated for each of said categories.

13. The method of claim 11 wherein said top prospects are constituents most likely to donate to an organization, and wherein said rating elements quantify the likelihood that a constituent will donate to an organization.

14. The method of claim 13 wherein said rating elements include commitment rating elements representing a commitment to said organization, concern rating elements representing concerns matching values of said organization, and capacity rating elements representing a financial capacity of said prospects.

15. The method of claim 14 wherein said commitment rating elements include a connection element representing a connection of a prospect to said organization, a gift recency element representing a most recent gift made by a prospect to said organization, and a gift frequency element representing how often a prospect makes a gift to said organization.

16. The method of claim 15 wherein said capacity rating elements include an average gift size element, a largest gift size element, and a total giving element.

17. The method of claim 11 wherein said customization user interface includes a prospect rating settings profile for allowing said user to enter said relative weight values, said rating parameters, and said rating values.

18. The method of claim 11 further comprising adjusting said relative weight values, said rating parameters, and said rating values.

19. The method of claim 11 further comprising recalculating said raw ratings when changes occur in at least one of said constituent data, said relative weight values, said rating parameters, and said rating values.

20. The method of claim 19 further comprising outputting rating information indicating prospects having a rating change.

21. The method of claim 11 further comprising directly adjusting a raw rating for at least one said constituents.

22. The method of claim 11 wherein outputting said rating information includes displaying said rating information.

23. The method of claim 11 wherein outputting said rating information includes providing prospect reports.

24. The method of claim 11 wherein outputting said rating information includes outputting at least one of said overall raw rating and said percentile ranking for selected ones of said constituents.

25. The method of claim 11 further comprising uploading said constituent data from a third party database.

26. A system for determining top prospects from among a plurality of constituents based on a plurality of rating elements, said system comprising:
a customization user interface for receiving customized rating criteria for each of said rating elements;
a rating element data structure for storing said customized rating criteria;
a constituent database containing constituent data for each of said constituents;
a rating engine for applying said customized rating criteria to said constituent data for each of said constituents, for calculating raw ratings for each of said rating elements, and for ranking each of said constituents based on said raw ratings; and
an output device for outputting rating information.

27. A computer program product, stored on a storage medium, for determining top prospects from among a plurality of constituents based on a plurality of rating elements, wherein said top prospects are most likely to give to an organization, said computer program product comprising:
code for receiving customized rating criteria from a user for allowing the user to customize said rating elements, wherein said rating elements include at least commitment rating elements for measuring a commitment made by a constituent to the organization, concern rating elements for measuring a concern of a constituent matching concerns of the organization, and capacity rating elements for measuring a financial ability of a constituent to give to the organization;
code for applying said customized rating criteria to constituent data corresponding to each of said constituents and calculating raw ratings for each of said rating elements based upon said constituent data for each of said constituents;
code for ranking each of said constituents based on said raw ratings; and
code for outputting rating information indicating said top prospects.

28. A computer program product stored on a storage medium, for determining top prospects from among a plurality of constituents based on a plurality of rating elements, said computer program product comprising:
code for displaying a customization user interface for allowing a user to customize said rating elements;
code for assigning relative weight values to each of said rating elements, wherein said relative weight values represent an importance of each of said rating elements in determining said top prospects;
code for setting rating parameters and rating values corresponding to said rating parameters for each of said rating elements;
code for applying said rating parameters to constituent data corresponding to each of said constituents and calculating raw ratings for each of said rating elements based on said rating values and said relative weight values;
code for calculating at least one of an overall raw rating and percentile ranking for each of said constituents, wherein said overall raw rating is a sum of said raw ratings calculated for each of said rating elements, and wherein said percentile ranking ranks each of said constituents with respect to other said constituents; and
code for outputting rating information indicating said top prospects.

29. The computer program product of claim 28 wherein said top prospects are constituents most likely to donate to an organization.

30. The computer program product of claim 29 wherein said rating elements include commitment rating elements representing a commitment to said organization, concern rating elements representing concerns matching values of said organization and capacity rating elements representing financial capacity of said prospects.
